(19) United States
(12) Patent Application Publication
(10) Pub. No.: US 2003/0183463 A1
(43) Pub. Date: Oct. 2, 2003

(54) Mounting piece of a disc brake for bicycles

(76) Inventor: Chin-Fu Wu, Nan-Tou (TW)

Correspondence Address: CHIN-FU WU, NO.15, INDUSTRY RD., NANKANG INDUSTRIAL DISTRICT, NAN-TOU, 540, TW

(21) Appl. No.: 10/107,752

(22) Filed: Mar. 28, 2002

(51) Int. Cl. F16D 55/00

(52) U.S. Cl. 188/73.31

(57) ABSTRACT

The present invention relates to a mounting piece of a disc brake for bicycles which includes a main body and an extension arm at the top of the main body. The extension arm with arched projections has a through hole at both ends thereof, respectively. The main body has a connection recess, thereby creating a restricting wall between the extension arm and the connection recess. The main body further comprises a slide piece laterally disposed at the opening of the rear fork. The slide piece is divided into two parts by an indent with the opening directed downwards. And the slide piece adjacent to the opening of the rear fork has a threaded hole extended to the indent so that adjusting element (or screw) can be screwed into the threaded hole. Accordingly, the disc-brake system is optionally installable to achieve the fine adjustment of the hub axle.

### BACKGROUND OF THE INVENTION

1. Fields of the Invention

The present invention relates to a mounting piece of a disc brake for bicycles.

2. Description of the Prior Art

Bicycle is a vehicle utilizing rotation of both wheels to achieve the aim of displacement. In hindering the forward movement, a braking system has to be used for deceleration of the wheels until stop. The well-known braking system can be divided into caliper brakes and disc brakes, and the latter is better than the former with respect to the braking efficiency.

Most of the bicycles are fitted with the caliper brake except that the bicycles are made in accordance with the specific requirements of the buyers. This braking system is fitted to the rear fork or the seat tube adjacent to the wheel frame. The braking effect is achieved by means of the cross clamping with single pivot point or opposite clamping with double pivot point.

In order to fit the disc brake of high braking efficiency to the fork end of the rear stay, a fixing piece is directly welded to the rear fork end for receiving the caliper of the main part of the disc-brake assembly. However, this still has its drawbacks which are concluded as follows:

a) The rear fork frame is provided with rear forks between which an axle hub is interposed. A disc brake plate is secured to one side of the axle while a chainwheel is connected to the other side thereof. Nevertheless, the fine adjustment of both ends to the concentricity is hardly achieved.

b) After the caliper is secured to the fixing piece, its corresponding position to the brake disc can't be adjusted so that the wearing rate of both brake pads is different, thereby reducing the braking efficiency and the service life.

### SUMMARY OF THE INVENTION

It is a primary object of the present invention to eliminate the above-mentioned drawbacks and to provide a mounting piece of a disc brake for bicycles through which the disc-brake system is optionally installable to achieve the fine adjustment of the hub axle.

It's another object of the present invention to provide a mounting piece of a disc brake for bicycles through which the fine adjustment of the hub axle is achieved.

### BRIEF DESCRIPTION OF THE DRAWINGS

The accomplishment of this and other objects of the invention will become apparent from the following description and its accompanying drawings of which:

FIG. 1 is a perspective view of a preferred embodiment of the present invention;

FIG. 2 is a perspective view of FIG. 1 while the disc-brake system and the hub are assembled to the rear fork; and

FIG. 3 is a schematic drawing of FIG. 2, showing the movement of the present invention on the rear fork.

### DETAILED DESCRIPTION OF THE PREFERRED EMBODIMENT

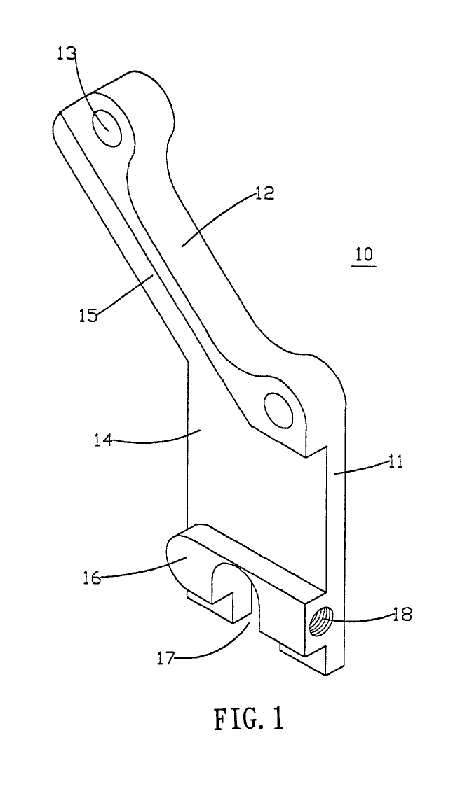

First of all, referring to FIG. 1, the mounting piece 10 of the present invention includes a main body 11 and an extension arm 12 at the top of the main body 11. The extension arm 12 with arched projections has a through hole 13 at both ends thereof, respectively. The main body 11 has a connection recess 14, thereby creating a restricting wall 15 between the extension arm 12 and the connection recess 14. The main body 11 further comprises a slide piece 16 laterally disposed at a proper position thereof. The slide piece 16 is divided into two parts by an indent 17 with the opening directed downwards. One of both parts has a threaded hole 18 extended to the indent 17.

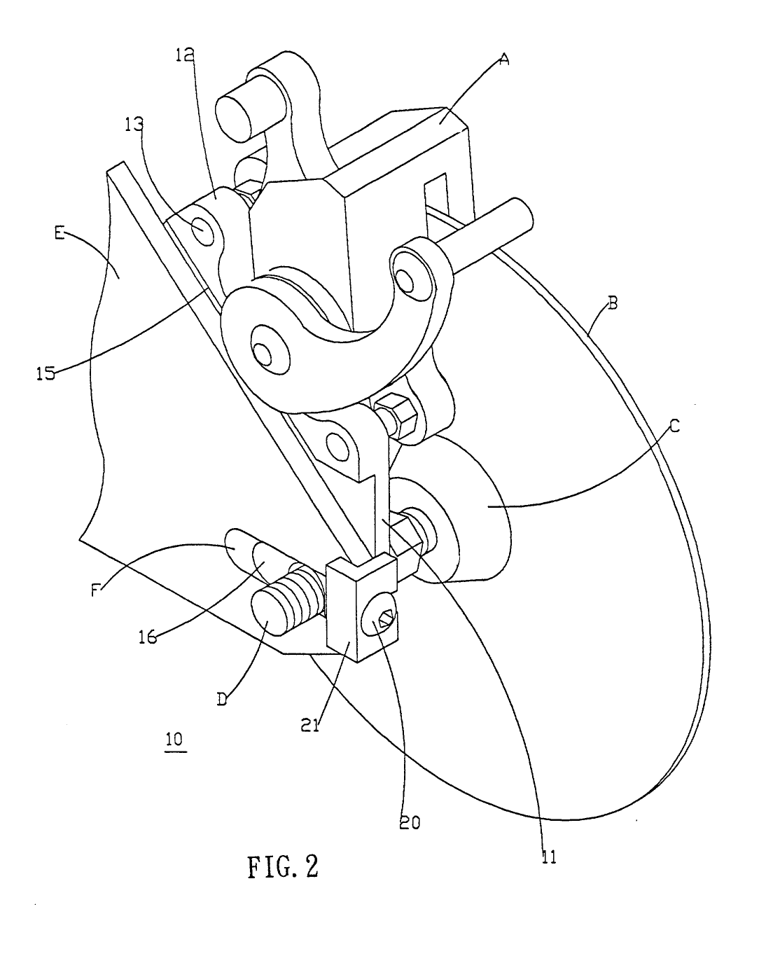

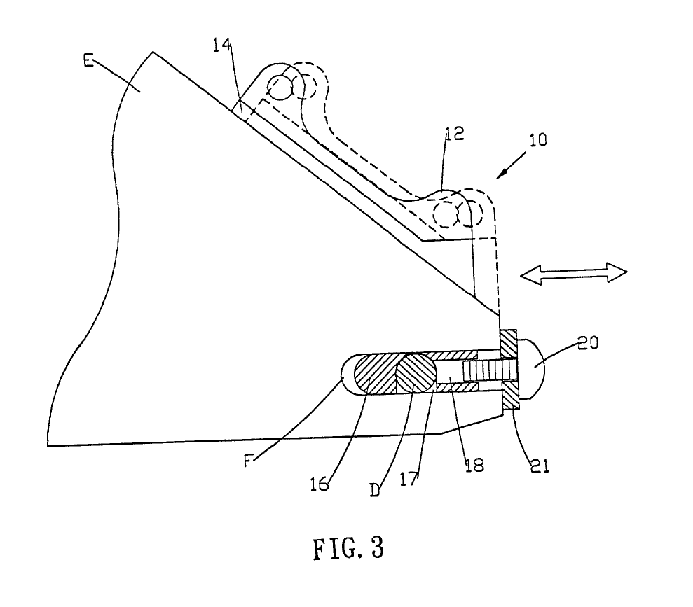

Referring to FIGS. 2 and 3, the caliper A is fitted to the through hole 13 of the extension arm 12 at the top of the mounting piece. After the brake disc B is inserted on the axle D and fixed to the side of the hub C, the axle D is disposed in the indent 17 at the bottom of the main body 11. Thereafter, the assembly of the hub C, the brake disc B the mounting piece 10 and the caliper A is interposed between two rear forks E of the fork frame (not shown) in such a way that the side of the rear fork E is flatly attached to the connection recess 14 of the mounting piece 10. In addition, the slide piece 16 together with the axle D is laterally placed into an indentation F of the rear fork E. When the other side of the axle D is assembled to the chainwheel (not shown) engaging with a power chain (not shown), both ends thereof are located in position (but not tightened).

A locating seat 21 is fitted to the opening the indentation F of the rear fork E so that an adjusting element 20 passes through the locating seat 21 and is screwed into the threaded hole 18 of the slide piece 16. Based on the locating seat 21, the mounting piece 10 is moved by the adjusting element 20 along the horizontal direction of the drawing so that the axle D within the indent 17 is moved within the indentation F in a coupled way until both ends of the axle D are aligned on a phantom line. Finally, the adjusting element 20 is tightened.

The above-mentioned embodiment has the following advantages:

1. The common bicycle with the conventional caliper brake can be optionally and easily fitted with the disc-brake system by means of the mounting piece 10 of the present invention.

2. Both ends of the axle can be adjusted to reduce the deviation therebetween by means of the mounting piece.

3. No matter how the mounting piece 10 is moved by adjustment, the relative position of the caliper and the brake disc won't be changed. Moreover, the braking efficiency and the service life of the disc brake is better than the prior art.

4. The restricting wall 15 is designed in accordance with the shape of the rim of the rear fork. When the mounting piece 10 is laterally moved, the restricting wall 15 serves to avoid the separation of the adjusting element 20 from the threaded hole

Another embodiment of the present invention can be designed without the threaded hole 18, the adjusting element 20 and the locating seat 21, thereby forming a simple mounting piece of a disc brake without the function of deviation adjustment. Further embodiments are that the indent 17 can be replaced by any through hole, or the adjusting element 20 is replaced by any kind of screws.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mounting piece of a disc brake for bicycles comprising:
a main body having a connection recess, thereby creating a restricting wall between extension arm and said connection recess, and a slide piece laterally disposed at a proper position thereof, said slide piece having in the middle thereof an indent or a through hole with the opening directed downwards; and
an extension arm at the top of the main body having a through hole at both ends thereof, respectively;
so that the caliper is fitted into said through hole of said extension arm while said caliper corresponds to the brake disc at the side of the hub axle in such a way that said axle is inserted into said indent or said through hole of said slide piece, thereby mounting to the opening position of the rear fork of bicycles and, therefore, achieving the optional and easy assembly of the disc-brake system.

2. The mounting piece as recited in claim 1, wherein said slide piece has a threaded hole adjacent to the opening of the rear fork and extended to said indent or said through hole so that the main body at the place of said rear fork can be moved along the opening direction by a locating seat and an adjusting element to adjust the deviation between both ends of said axle.
